(19) United States
(12) Patent Application Publication
(10) Pub. No.: US 2024/0201745 A1
(43) Pub. Date: Jun. 20, 2024

(54) DISPLAY PROTECTION DEVICE

(71) Applicant: Ronald Chesnut, Corbin, KY (US)

(72) Inventor: Ronald Chesnut, Corbin, KY (US)

(21) Appl. No.: 18/083,149

(22) Filed: Dec. 16, 2022

(51) Int. Cl. G06F 1/16

(52) U.S. Cl. CPC G06F 1/1656

(57) ABSTRACT

A display protection device, including a main body, including a magnification side to magnify a display screen while disposed on the display screen and prevent damage to the display screen, and an adhesive side disposed on at least a portion of the magnification side to removably connect to at least a portion of the display screen, an adhesive cover removably connected to at least a portion of the adhesive side to prevent damage to the adhesive side prior to connecting the adhesive side on the display screen, and a tab disposed on at least a portion of the adhesive cover to facilitate removal of the adhesive cover from the adhesive side.

### BACKGROUND

### 1. Field

The present general inventive concept relates generally to a display protector, and particularly, to a display protection device.

### 2. Description of the Related Art

There are many different types of computing devices with a display, such as smartphones, tablet computers, laptop computers, desktop computers, and/or televisions. Some of these computing devices allow a user to zoom on the display to increase size on a portion of the display. However, zooming on the display will distort the display and prevent the user from having full view of the display.

Additionally, a loss of a full view on a website to view specific content can be tiresome by having the user zoom in and out repeatedly while reading a large article, looking at a picture, and/or watching a video. Also, zooming in tends to remove functionality as certain features of the website and/or the video disappear.

Therefore, there is a need for a display protection device that enlarges elements on the display while providing protection for the display.

### SUMMARY

The present general inventive concept provides a display protection device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a display protection device, including a main body, including a magnification side to magnify a display screen while disposed on the display screen and prevent damage to the display screen, and an adhesive side disposed on at least a portion of the magnification side to removably connect to at least a portion of the display screen, an adhesive cover removably connected to at least a portion of the adhesive side to prevent damage to the adhesive side prior to connecting the adhesive side on the display screen, and a tab disposed on at least a portion of the adhesive cover to facilitate removal of the adhesive cover from the adhesive side.

The magnification side may have a first portion with a first magnification level, and a second portion with a second magnification level greater than the first magnification level.

The magnification side may prevent damage from at least one of a scratch, a ding, a dent, dirt, and a liquid.

The magnification side may absorb at least one impact thereon to prevent the display screen from at least one of cracking and shattering.

The display protection device may further include a protecting edge perpendicularly disposed away from the adhesive side with respect to a direction to prevent damage to a side of the display screen.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a top isometric view of a display protection device, according to an exemplary embodiment of the present general inventive concept; and

FIG. 2 illustrates a top isometric view of the display protection device, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Display Protection Device 100
Main Body 110
Magnification Side 111
Adhesive Side 112
Protecting Edge 120
Adhesive Cover 130
Tab 140

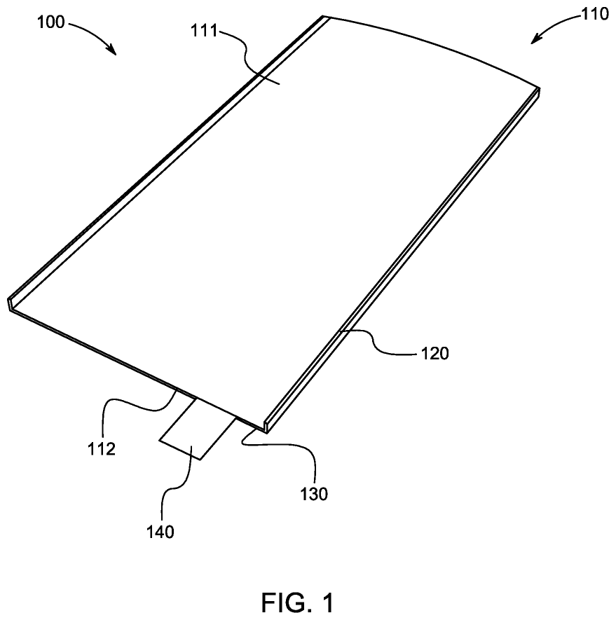

FIG. 1 illustrates a top isometric view of a display protection device 100, according to an exemplary embodiment of the present general inventive concept.

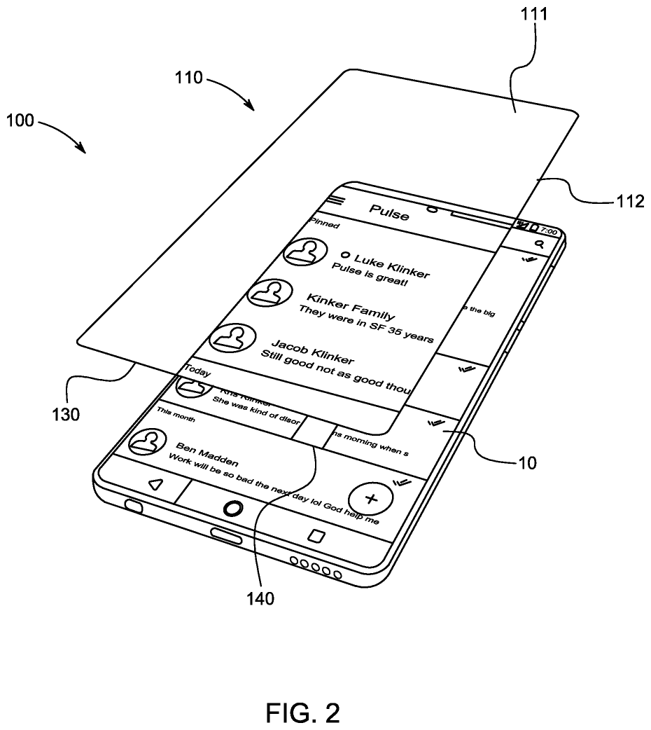

FIG. 2 illustrates a top isometric view of the display protection device 100, according to an exemplary embodiment of the present general inventive concept.

The display protection device 100 may be constructed from at least one of plastic, glass, metal, and rubber, etc., but is not limited thereto.

The display protection device 100 may include a main body 110, a protecting edge 120, an adhesive cover 130, and a tab 140, but is not limited thereto.

Referring to FIGS. 1 and 2, the main body 110 is illustrated to have a rectangular prism shape. However, the main body 110 may be rectangular, rounded rectangular, circular, cylindrical, triangular, pentagonal, hexagonal, heptagonal, octagonal, or any other shape known to one of ordinary skill in the art, but is not limited thereto.

The main body 110 may be constructed to have a size (e.g., a length, a width) and/or a shape corresponding to a size (e.g., a length, a width) and/or a shape of a display screen 10 of a computing device. In other words, the main body 110 may be designed based on a type of the computing device. For example, the main body 110 used for a cell phone may be smaller than the main body 110 used for a television. As such, the main body 110 may be applied for a variety of the computing device, such as a cell phone, a tablet computer, a laptop computer, a desktop computer, a television, a keypad, a gaming device, a vehicle display, a baby monitor, a medical equipment, a copy machine, a heavy equipment, and/or any other device with a digital display.

The main body 110 may be transparent to allow full use of touchscreen functionality on the display screen 10 and/or without obstructing other operations on the display screen 10.

The main body 110 may include a magnification side 111 and an adhesive side 112, but is not limited thereto.

The magnification side 111 may be disposed on at least a portion of a first die of the main body 110. The magnification side 111 may refract light moving therethrough. Moreover, the magnification side 111 may magnify the display screen 10 while disposed on the display screen 10 in response to being viewed by a user. As such, the magnification side 111 may enhance and/or improve viewing of the display screen 10 by the user. Also, the magnification side 111 may have different levels of magnification thereon. For example, a first portion of the magnification side 111 may have a first magnification level, and a second portion of the magnification side 111 may have a second magnification level greater than the first magnification level. Alternatively, more portions may be used on the magnification side 111 with a variety (i.e., plurality) of different magnification levels.

Furthermore, the magnification side 111 may be rigid and/or highly durable. The magnification side 111 may protect the display screen 10 while disposed on the display screen 10. For example, the magnification side 111 may prevent damage to the display screen 10 from scratches, dings, dents, dirt, oil, and/or any other liquid. Also, the magnification side 111 may absorb at least one impact thereon to prevent the display screen 10 from cracking and/or shattering as a result of a fall and/or dropping the display screen 10 with the main body 110.

Thus, the magnification side 111 may improve viewing of the display screen 10 without using reading glasses and/or distorting images.

The adhesive side 112 may be disposed on at least a portion of a second side of the main body 110 opposite with respect to the first side. The adhesive side 112 may be an adhesive substrate, such as tape and/or glue. As such, the adhesive side 112 may removably connect (e.g., affix, adhere) to at least a portion of an external surface. For example, the adhesive side 112 may removably connect to at least a portion of the display screen 10. Thus, the adhesive side 112 may prevent movement (e.g., falling off) from the display screen 10 in absence of an application of force (e.g., pushing, pulling) by the user.

Accordingly, the magnification side 111 may be disposed away from the display screen 10 while the adhesive side 112 is disposed on the display screen 10.

The protecting edge 120 may be disposed on at least a portion of an edge of the main body 110 (i.e., the magnification side 111 and/or the adhesive side 112). The protecting edge 120 may perpendicularly extend away from the adhesive side 112 with respect to a direction. As such, the protecting edge 120 may cover at least a portion of a side of the display screen 10 of the computing device, such that the protecting edge 120 may prevent damage to the side of the display screen 10.

The adhesive cover 130 may be removably connected to at least a portion of the adhesive side 112. More specifically, the adhesive cover 130 may cover the adhesive side 111 prior to use on the display screen 10. The adhesive cover 130 may prevent the adhesive side 112 from being damaged and/or lose any adhesive property prior to connecting to the display screen 10.

The tab 140 may be disposed on at least a portion of the adhesive cover 130. The tab 140 may facilitate gripping thereof. As such, the tab 140 may facilitate removal of the adhesive cover 130 from the adhesive side 111.

Therefore, the display protection device 100 may improve viewing of the display screen 10 without requiring the user to zoom on the display screen 10. Also, the display protection device 100 may protect the display screen 10 from damage.

The present general inventive concept may include a display protection device 100, including a main body 110, including a magnification side 111 to magnify a display screen 10 while disposed on the display screen 10 and prevent damage to the display screen 10, and an adhesive side 112 disposed on at least a portion of the magnification side 111 to removably connect to at least a portion of the display screen 10, an adhesive cover 130 removably connected to at least a portion of the adhesive side 112 to prevent damage to the adhesive side 112 prior to connecting the adhesive side 112 on the display screen 10, and a tab 140 disposed on at least a portion of the adhesive cover 130 to facilitate removal of the adhesive cover 130 from the adhesive side 112.

The magnification side 111 may have a first portion with a first magnification level, and a second portion with a second magnification level greater than the first magnification level.

The magnification side 111 may prevent damage from at least one of a scratch, a ding, a dent, dirt, and a liquid.

The magnification side 111 may absorb at least one impact thereon to prevent the display screen 10 from at least one of cracking and shattering.

The display protection device 100 may further include a protecting edge 120 perpendicularly disposed away from the adhesive side 112 with respect to a direction to prevent damage to a side of the display screen 10.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A display protection device, comprising:
a main body, comprising:
a magnification side to magnify a display screen while disposed on the display screen and prevent damage to the display screen, and
an adhesive side disposed on at least a portion of the magnification side to removably connect to at least a portion of the display screen;
an adhesive cover removably connected to at least a portion of the adhesive side to prevent damage to the adhesive side prior to connecting the adhesive side on the display screen; and
a tab disposed on at least a portion of the adhesive cover to facilitate removal of the adhesive cover from the adhesive side.

2. The display protection device of claim 1, wherein the magnification side has a first portion with a first magnification level, and a second portion with a second magnification level greater than the first magnification level.

3. The display protection device of claim 1, wherein the magnification side prevents damage from at least one of a scratch, a ding, a dent, dirt, and a liquid.

4. The display protection device of claim 1, wherein the magnification side absorbs at least one impact thereon to prevent the display screen from at least one of cracking and shattering.

5. The display protection device of claim 1, further comprising:
a protecting edge perpendicularly disposed away from the adhesive side with respect to a direction to prevent damage to a side of the display screen.
